(19) United States
(12) Patent Application Publication
(10) Pub. No.: US 2003/0136534 A1
(43) Pub. Date: Jul. 24, 2003

(54) Aqueous silica-containing composition

(76) Inventors: Hans Johansson-Vestin, Kungalv (SE); Johan Nyander, Sollentuna (SE); Jan Nordin, Kvissleby (SE)

Correspondence Address: Michelle J. Burke, Akzo Nobel, Inc., IP Department, 7 Livingstone Avenue, Dobbs Ferry, NY, 10522, US

(21) Appl. No.: 10/326,320

(22) Filed: Dec. 20, 2002

Related U.S. Application Data
(60) Provisional application No. 60/342,306, filed on Dec. 21, 2001.

(51) Int. Cl. D21H 17/00; D21H 17/28; D21H 17/44; D21H 17/55; D21H 17/68; C08L 97/00; C09D 197/00

(52) U.S. Cl. 162/158; 162/164.1; 162/175; 162/168.3; 162/181.6; 106/123.11; 524/493

(57) ABSTRACT

The present invention relates to an aqueous silica-containing composition comprising an anionic organic polymer having at least one aromatic group and anionic aggregated or microgel formed silica-based particles. The aqueous silica-containing composition contains the anionic organic polymer having at least one aromatic group and the anionic silica-based particles in an amount of at least 0.01% by weight of the total weight of the aqueous silica-containing composition. The aqueous silica-containing composition contains substantially no cellulose-reactive sizing agent and the anionic organic polymer having at least one aromatic group is not an anionic naphthalene sulphonate formaldehyde condensate.

The invention further relates to methods for the preparation of the aqueous silica-containing composition and the use of the aqueous silica-containing composition as a drainage and retention aid in a process for the production of paper. The invention also relates to a process for the production of paper from an aqueous silica-containing composition and at least one charged organic polymer are added to the cellulosic suspension.

The present invention relates to an aqueous silica-containing composition comprising an anionic organic polymer having at least one aromatic group and anionic silica-based particles. The invention further relates to a method for the preparation of the aqueous silica-containing composition, uses of the aqueous silica-containing composition and a papermaking process.

### BACKGROUND OF THE INVENTION

In the papermaking art, an aqueous suspension containing cellulosic fibres, and optionally fillers and additives, referred to as stock, is fed into a headbox which ejects the stock onto a forming wire. Water is drained from the stock through the forming wire so that a wet web of paper is formed on the wire. The formed paper web is dewatered and dried in the drying section of the paper machine. Drainage and retention aids are conventionally introduced into the stock in order to facilitate drainage and to increase adsorption of fine particles onto the cellulosic fibres in such a way that the fine particles are retained with the fibres on the wire.

U.S. Pat. No. 4,388,150 discloses a binder in papermaking comprising a complex of cationic starch and colloidal silicic acid to produce a paper having increased strength and improved levels of retention of added minerals and papermaking fines.

U.S. Pat. No. 4,750,974 discloses a coarcervate binder for use in papermaking comprising a tertiary combination of a cationic starch, an anionic high molecular weight polymer and a dispersed silica.

U.S. Pat. No. 5,368,833 discloses silica sols containing aluminium modified silica particles with high specific surface area and a high content of microgel.

U.S. Pat. No. 5,567,277 discloses a composition comprising an aqueous cellulosic furnish, a high molecular weight cationic polymer and an anionic polymer comprising modified lignin.

U.S. Pat. No. 6,022,449 discloses the use of water-dispersible polyisocyanates with anionic and/or potentially anionic groups and cationic and/or potentially cationic compounds in paper finishing.

EP 0 418 015 A1 discloses an active sizing composition containing an aqueous emulsion in combination with an anionic dispersant or emulsifier. By using anionic polyacrylamide, anionic starch or colloidal silica the anionic charge density in the sizing composition can be extended.

U.S. Pat. No. 5,670,021 refers to a process for the production of paper by forming and dewatering a suspension of cellulose, wherein the dewatering takes place in the presence of an alkali metal silicate and a phenolic resin added at the same point into the suspension.

U.S. Pat. No. 6,033,524 discloses a method for increasing retention and drainage of filling components in a paper making furnish in a paper making process comprising adding to the furnish a slurry of filling components, also containing a phenolic enhancer.

U.S. Pat. No. 6,315,824 pertains to a dispersed composition comprising a hydrophobic phase and an aqueous phase, the composition being stabilised by a cationic colloidal coacervate stabilising agent, the coacervate stabilising agent comprising an anionic component and a cationic component.

EP 0,953,680 A1 refers to a process for the production of paper from s suspension comprising adding to the suspension a cationic organic polymer.

U.S. Pat. No. 5,185,062 discloses a papermaking process including the steps of adding to the papermaking slurry a high molecular weight cationic polymer and then a medium molecular weight anionic polymer.

U.S. Pat. No. 4,313,790 refers to a process for the production of paper which consists of the addition to the papermaking furnish of kraft lignin or modified kraft lignin and poly(oxyethylene).

U.S. Pat. No. 6,165,259 relates to an aqueous dispersion containing a dispersant and a disperse phase containing a hydrophobic material, the dispersant comprising an anionic compound and a cationic compound.

It would be advantageous to be able to provide drainage and retention aids with improved performance. It would also be advantageous to be able to provide retention and drainage aids with good storage stability. It would further be advantageous to be able to provide a papermaking process with improved drainage and/or retention performance.

### THE INVENTION

According to the present invention it has unexpectedly been found that an improved drainage and/or retention effect of a cellulosic suspension on a wire can be obtained by using an aqueous silica-containing composition comprising at least one anionic organic polymer with at least one aromatic group and anionic aggregated or microgel formed silica-based particles. The aqueous silica-containing composition is useful in processes for production of paper from all types of stocks, in particular stocks having high contents of salts (high conductivity) and colloidal substances. The aqueous silica-containing composition is also useful in papermaking processes with a high degree of white water closure, i.e. extensive white water recycling and limited fresh water supply. Hereby the present invention makes it possible to increase the speed of the paper machine and to use a lower dosage of additi ves to give a corresponding drainage and/or retention effect, thereby leading to an improved papermaking process and economic benefits.

The terms “drainage and retention aid”, as used herein, refer to one or more components, which when added to an aqueous cellulosic suspension, give better drainage and/or retention than is obtained when not adding the said one or more components. All types of stocks, in particular stocks having high contents of salts (high conductivity) and colloidal substances will obtain better drainage and retention performances by the addition of the composition according to the present invention. This is important in papermaking processes with a high degree of white water closure, i.e. extensive white water recycling and limited fresh water supply.

In accordance with the present invention there is provided an aqueous silica-containing composition comprising an anionic organic polymer having at least one aromatic group and anionic silica-based particles comprising aggregated or microgel formed silica-based particles. The aqueous silica-containing composition contains the anionic organic polymer having at least one aromatic group and total amount of anionic silica-based particles in an amount of at least 0.01% by weight based on the total weight of the aqueous silica-containing composition. The composition contains substantially no cellulose-reactive sizing agent and the said anionic organic polymer is not an anionic naphthalene sulphonate formaldehyde condensate.

There is further provided an aqueous silica-containing composition obtainable by mixing an anionic organic polymer having at least one aromatic group with an aqueous alkali stabilised silica sol containing aggregated or microgel formed silica-based particles having an S-value in the range of from about 5 up to about 50%. The obtained aqueous silica-containing composition contains the anionic organic polymer having at least one aromatic group and total amount of silica-based particles in an amount of at least 0.01% by weight based on the total weight of the aqueous silica-containing composition. The composition contains substantially no cellulose-reactive sizing agent and that said anionic organic polymer is not anionic naphthalene sulphonate formaldehyde condensate.

There is further provided a method for preparation of an aqueous silica-containing composition which comprises mixing in the presence of substantially no cellulose-reactive sizing agent an anionic organic polymer having at least one aromatic group with aggregated or microgel formed silica-based particles to provide an aqueous silica-containing composition containing the anionic organic polymer having at least one aromatic group and total amount of silica-based particles in an amount of at least 0.01% by weight, based on the total weight of the aqueous silica-containing composition with the proviso that the anionic organic polymer having at least one aromatic group is not an anionic naphthalene sulphonate formaldehyde condensate.

There is further provided a method for preparation of an aqueous silica-containing composition which comprises mixing an anionic organic polymer having at least one aromatic group and a charge density of at least 0.1 meq/g of dry polymer, with aggregated or microgel formed silica-based particles to provide an aqueous silica-containing composition containing the anionic organic polymer having at least one aromatic group and total amount of silica-based particles in an amount of at least 0.01% by weight, based on the total weight of the aqueous silica-containing composition, with the proviso that the anionic organic polymer having at least one aromatic group is not an anionic naphthalene sulphonate formaldehyde condensate.

There is further provided a method for preparation of an aqueous silica-containing composition which comprises desalinat ing an aqueous solution of an anionic organic polymer having at least one aromatic group, mixing in the desalinated anionic organic polymer having at least one aromatic group with aggregated or microgel formed silica-based particles to provide an aqueous silica-containing composition containing the anionic organic polymer having at least one aromatic group and total amount of silica-based particles in an amount of at least 0.01% by weight, based on the total weight of the aqueous silica-containing composition with the proviso that the anionic organic polymer having at least one aromatic group is not an anionic naphthalene sulphonate formaldehyde condensate.

There is further provided an aqueous silica-containing composition obtainable by the methods according to the invention.

The invention further relates to the use of the aqueous silica-containing composition of the invention, as flocculating agent in combination with at least one cationic organic polymer in the production of pulp and paper and for water purification.

According to the invention there is further provided a process for the production of paper from a suspension containing cellulosic fibres, and optionally fillers, comprising adding to the suspension at least one cationic organic polymer and an aqueous silica-containing composition according to the invention.

The aqueous silica-containing composition comprises at least one anionic organic polymer with at least one aromatic group, which is not an anionic naphthalene sulfonate formaldehyde condensate. The aromatic group of the anionic polymer can be present in the polymer backbone or in a substituent group that is attached to the polymer backbone (main chain). Examples of preferably aromatic groups include aryl, aralkyl and alkaryl groups and derivatives thereof, e.g. phenyl, tolyl, naphthyl, phenylene, xylylene, benzyl, phenylethyl and derivatives of these groups. The anionically charged groups can be present either in the anionic polymer or in the monomers used for preparing the anionic polymer. The anionically charged groups can either be groups carrying an anionic charge or acid groups carrying an anionic charge when dissolved or dispersed in water. These groups are herein collectively being referred to as anionic groups, such as phosphate, phosphonate, sulphate, sulphonic acid, sulphonate, carboxylic acid, carboxylate, alkoxide and phenolic groups, i.e. hydroxy-substituted phenyls and naphthyls. Groups carrying an anionic charge are usually salts of an alkali, alkaline earth metals or ammonia.

Anionic polymers containing one or more aromatic groups according to the invention can preferably be selected from the group consisting of step-growth polymers, chain-growth polymers, polysaccharides and naturally occurring aromatic polymers. The term “step-growth polymer”, as used herein, refers to a polymer obtained by step-growth polymerisation, also being referred to as step-reaction polymer and step-reaction polymerisation, respectively. Preferably the anionic polymer is a step-growth polymer. The anionic polymers according to the invention can be linear, branched or cross-linked. Preferably the anionic polymer is water-soluble or water-dispersible.

Examples of suitable anionic step-growth polymers according to the present invention include condensation polymers, i.e. polymers obtained by step-growth condensation polymerisation, e.g. condensates of an aldehyde such as formaldehyde with one or more aromatic compounds containing one or more anionic groups, and optional other co-monomers useful in the condensation polymerisation such as urea and melamine. Examples of suitable aromatic compounds containing anionic groups comprises compounds containing anionic groups such as phenolic compounds, e.g. phenol, resorcinol and derivatives thereof, aromatic acids and salts thereof.

Examples of suitable anionic step-growth polymers according to the present invention include addition polymers, i.e. polymers obtained by step-growth addition polymerisation, e.g. anionic polyurethanes prepared from a monomer mixtu re comprising aromatic isocyanates and/or aromatic alcohols. Examples of suitable aromatic isocyanates include diisocyanates, e.g. toluene-2,4- and 2,6-diisocyanates and diphenylmethane-4,4′-diisocyanate. Examples of suitable aromatic alcohols include d ihydric alcohols, i.e. diols, e.g. bisphenol A, phenyl diethanol amine, glycerol monoterephthalate and trimethylol-propane monoterephthalate. M onohydric aromatic alcohols such as phenol and derivatives thereof may also be employed. The monomer mixture c an also contain non-aromatic isocyanates and/or alcohols, usually diisocyanates and diols, for example any of those known to be useful in the preparation of polyurethanes. Examples of suitable monomers containing anionic groups include the monoester reacti on products of triols, e.g. trimethylolethane, trimethylolpropane and glycerol, with dicarboxylic acids or anhydrides thereof, e.g. succinic acid and anhydride, terephthalic acid and anhydride, such as glycerol monosuccinate, glycerol monoterephthalate, tri methylolpropane monosuccinate, trimethylolpropane monoterephthalate, N,N-bis-(hydroxyethyl)-glycine, di-(hydroxy-methyl)propionic acid, N,N-bis-(hydroxyethyl)-2-aminoethanesulfonic acid, and the like, optionally and usually in combinat ion with reaction with a base, such as alkali and alkaline earth metal hydroxides, e.g. sodium hydroxide, ammonia or an amine, e.g. triethylamine, thereby forming an alkali, alkaline earth metals or ammonium counter-ion.

Examples of suitable anionic chain-growth polymers according to the invention include anionic vinyl addition polymers obtained from a mixture of vinylic or ethylenically unsaturated monomers. The mixture of vinylic or ethylenically unsaturated monomers comprises at least one monomer having an aromatic group and at least one monomer having an anionic group. Usually the monomers are co-polymerised with non-ionic monomers such as acrylate- and acrylamide-based monomers. Examples of suitable anionic monomers include (meth)acrylic acid and paravinyl phenol (hydroxy styrene).

Examples of suitable anionic polysaccharides with at least one aromatic group include starches, guar gums, cellulose derivatives, chitins, chitosans, glycans, galactans, glucans, xanthan gums, pectins, mannans, dextrins, preferably starches, and guar gums, preferably starches including potato, corn, wheat, tapioca, rice, waxy maize and barley, preferably potato. The anionic groups in the polysaccharide can be native and/or introduced by chemical treatment. The aromatic groups in the polysaccharide can be introduced by chemical methods known in the art.

Examples of suitable (modified) naturally occurring aromatic anionic polymers of this invention include lignosulphonates, Kraft lignins, oxylignins, and tannin extracts i.e. naturally occurring polyphenolic substances that are obtained from the sulphite or sulphate pulp processes or from extracts of bark.

The weight average molecular weight of the anionic polymer can vary within wide limits dependent on, inter alia, the type of polymer used, and usually it is at least about 500, preferably above about 800 and preferably above about 1,000. The upper limit is not critical; it can be about 10,000,000, usually 1,000,000, preferably 500,000, preferably 200,000 and most preferably 100,000.

The anionic polymer can have a degree of anionic substitution (DS_{A}) varying over a wide range dependent on, inter alia, the type of polymer used. DS_{A} is usually from 0.01 to 2.0, preferably from 0.02 to 1.8 and preferably from 0.025 to 1.5; and the degree of aromatic substitution (DS_{Q}) can be from 0.001 to 1.0, usually from 0.01 to 0.8, preferably from 0.02 to 0.7 and more preferably from 0.025 to 0.5. In case the anionic polymer contains cationic groups, the degree of cationic substitution (DS_{C}) can be, for example, from 0 to 0.2, preferably from 0 to 0.1 and more preferably from 0 to 0.05, the anionic polymer having an overall anionic charge. Usually the anionic charge of the anionic polymer is within the range of from 0.1 to 10.0 meq/g of dry polymer, preferably from 0.2 to 6.0 meq/g, and more preferably from 0.5 to 4.0 meq/g.

The aqueous silica-containing composition according to the invention also comprises anionic aggregated or microgel formed silica-based particles i.e. particles based on SiO₂, preferably formed by polymerising silicic acid, encompassing both homopolymers and copolymers. Optionally the silica-based particles can be modified and contain other elements, e.g. amine, aluminium and/or boron, which can be present in the aqueous phase and/or in the silica-based particles.

Examples of suitable aggregated or microgel formed silica-based particles include colloidal silica, colloidal aluminium-modified silica or aluminium silicate, and different types of polysilicic acid and mixtures thereof, either alone or in combination with other types of anionic silica-based particles. In the art, poly silicic acid is also referred to as polymeric silicic acid, polysilicic acid microgel, polysilicate and polysilicate microgel, which are all encompassed by the term polysilicic acid used herein. Aluminium-containing compounds of this type are commonly referred to as poly aluminosilicate and polyaluminosilicate microgel including colloidal aluminium-modified silica and aluminium silicate.

The anionic silica-based particles are in the colloidal range of particle size. This state comprises particles sufficiently small not to be affected by gravitational forces but sufficiently large not to show marked deviation from the propert ies of typical solutions, i.e. average particle size significantly less than 1 μm. The anionic silica-based particles have an average particle size preferably below about 50 nm, preferably below about 20 nm and more preferably in the range of from about 1 to about 50 nm, most preferably from about 1 up to about 10 nm. As conventional in silica chemistry, the particle size refers to the average size of the primary particles, which may be aggregated or non-aggregated.

Preferably, the silica-based particles have a specific surface area larger than 50 m²/g, preferably larger than 100 m²/g. The specific area can be up to 1700 m²/g, preferably up to 1300 m²/g and usually in the range from 300 to 1300 m² /g, preferably from 500 to 1050 m²/g. The specific surface area can be measured by means of titra tion with NaOH according to the method described by Sears, Analytical Chemistry 28(1956), 12, 1981-1983 or in U.S. Pat. No. 5,176,891. The given area thus represents the average specific surface area of the particles.

The total weight of the anionic organic polymer having at least one aromatic group and total amount of anionic silica-based particles contained in the aqueous silica-containing composition is at least 0.01% by weight, calculated on the total weight of the aqueous silica-containing composition, preferably at least 0.05% by weight, more preferably at least 0.1% by weight. Preferably the concentration of the anionic organic polymer having at least one aromatic group and the anionic silica-based particles is within the range of 1 to 45% by weight, preferably within the range of 2 to 35% by weight, most preferably 5 to 30% by weight.

The aqueous silica-containing composition can have an anionic charge density of at least 0.1 meq/g, usually the charge is within the range of from 0.1 to 10 meq/g, preferably within the range of from 0.1 to 8 meq/g, preferably within the range of from 0.1 to 6 meq/g, and most preferably within the range of from 0.2 to 4 meq/g.

The aqueous silica-containing composition according to the invention contains substantially no cellulose-reactive sizing agent. By substantially no means that less than or equal to 10% by weight, preferably less than 5%, preferably less than 1% by weight of cellulose-reactive sizing agent is present in the aqueous silica-containing composition. Most preferably there is no cellulose-reactive sizing agent in the aqueous silica-containing composition. Even more preferably, the aqueous silica-containing composition according to the invention contains substantially no sizing agent, preferably, contains no sizing agent.

The present invention relates further to a method for preparation of an aqueous silica-containing composition. The two components are preferably stirred together. The anionic organic polymer having at least one aromatic group can be added to an aqueous sol containing the silica-based particles or the silica-based particles can be added to an aqueous solution of anionic organic polymer having at least one aromatic group. The aqueous solution of anionic organic polymer having at least one aromatic group may be desalinated or deionisated. The desalination or deionisation can be carried out with dialysis, membrane filtration, ultrafiltration, reversed osmosis or ion exchange or the like. It is preferred that the desalination or deionisation is carried out by the use of ultra-filtration or dialysis. The pH of an aqueous solution of anionic organic polymer may be adjusted to the pH of the silica-based particles, prior to or after mixing the aqueous solution with the silica-based particles. The pH can be adjusted to at least pH 8.0, preferably at least 9.0, preferably at least 9.5, preferably within the range of 9.0 to 11.0.

The anionic organic polymer having at least one aromatic group to be mixed with the silica-based particles can have an anionic charge density of at least 0.1 meq/g, usually within the range of from 0.1 to 10.0 meq/g of dry polymer, preferably within the range of from 0.2 to 6.0 and preferably within the range of from 0.5 to 4.0.

The silica-based particles, preferably anionic, to be mixed with the anionic organic polymer can have the previous mentioned properties. Preferably the silica-based particles are contained in a sol. The sol may have an S-value in the range of from 5 to 80%, preferably from 5 to 50%, preferably from 8 to 45%, and most preferably from 10 t o 30%. Calculation and measuring of the S-value can be performed as described by Iler & Dal ton in J. Phys. Chem. 60(1956), 955-957. The S-value indicates the degree of aggregate or microgel formation and a lower S-value is indicative of a higher degree of aggregation.

Preferably the silica-based particles have a molar ratio Si₂O:Na₂O less than 60, usually within the range 5 to 60, and preferably within the range from 8 to 55.

The aqueous silica-containing composition obtained by any of the methods according to the invention, contains preferably a total weight of the anionic organic polymer having at least one aromatic group and total amount of anionic silica-based of at least 0.01% by weight, calculated on the total weight of the aqueous silica-containing composition, preferably at least 0.05% by weight, more preferably at least 0.1% by weight. Preferably the concentration of anionic organic polymer having at least one aromatic group and anionic silica-based particles is within the range of 1 to 45% by weight, preferably within the range of 2 to 35% by weight, most preferably 5 to 30% by weight.

The products prepared by any of these methods shows improved drainage and retention properties, and also a better storage stability and therefore a better d rainage and retention aid performance when stored because it has a longer shelf life.

The mixing procedure of above mention methods is preferably carried out in the presence of substantially no cellulose-reactive sizing agent. By substantially no means that less or equal to 10% by weight, preferably less than 5%, preferably less than 1% by weight of cellulose-reactive sizing agent is present. Most preferably there is no cellulose-reactive sizing agent present. The mixing procedure may also be carried out in the presence of substantially no sizing agent, or in the presence of no sizing agent.

The present invention further relates to a process for the production of paper from an aqueous suspension containing cellulosic fibres. The process comprises adding to the suspension a cationic organic polymer and the aqueous silica-containing composition of the invention. The cationic organic polymer according to the invention can be linear, branched or cross-linked. Preferably the cationic polymer is water-soluble or water-dispersible.

Examples of suitable cationic polymers include synthetic organic polymers, e.g. step-growth polymers and chain-growth polymers, and polymers derived from natural sources, e.g. polysaccharides.

Examples of suitable cationic synthetic organic polymers include vinyl addition polymers such as acrylate- and acrylamide-based polymers, as well as cationic poly(diallyl dimethyl ammonium chloride), cationic polyethylene imines, cationic polyamines, polyamidoamines and vinylamide-based polymers, melamine-formaldehyde and urea-formaldehyde resins.

Examples of suitable polysaccharides include starches, guar gums, cellulose derivatives, chitins, chitosans, glycans, galactans, glucans, xanthan gums, pectins, mannans, dextrins, preferably starches a nd guar gums. Examples of preferably starches include potato, corn, wheat, tapioca, rice, waxy maize, barley, etc.

Cationic starches and cationic acrylamide-based polymers are preferred polymers according to the invention, and they can be used singly, together with each other or together with other polymers, particularly preferred are cationic starches and cationic acrylamide-based polymers having at least one aromatic group.

The cationic organic polymers can have one or more hydrophobic groups attached to them. The hydrophobic groups can be aromatic groups, groups comprising aromatic groups or non-aromatic groups, preferably the hydrophobic groups comprise aromatic groups. The hydrophobic group can be attached to a heteroatom, e.g. nitrogen or oxygen, the nitrogen optionally being charged, which heteroatom, it can be attached to the polymer backbone, for example via a chain of atoms. The hydrophobic group may have at least 2 and usually at least 3 carbon atoms, preferably from 3 to 12 and preferably from 4 to 8 carbon atoms. The hydrophobic group is preferably a hydrocarbon chain.

Preferable dosages counted as dry substance based on dry pulp and optional filler, of the cationic polymer in the system is from 0.01 to 50 kg/t (kg/tonne, “metric ton”) of, preferably from 0.1 to 30 kg/t and most preferably from 1 to 15 kg/t.

Preferable dosages counted as dry substances based on dry pulp and optional filler, of the aqueous silica-containing composition defined above in the system are from 0.01 to 15 kg/t, preferably from 0.01 to 10 kg/t calculated as an anionic organic polymer having at least one aromatic group and anionic silica-based particles, and most preferably from 0.05 to 5 kg/t.

Suitable mineral fillers of conventional types may be added to the aqueous cellulosic suspension according to the invention. Examples of suitable fillers include kaolin, china clay, titanium dioxide, gypsum, talc and natural and synthetic calcium carbonates such as chalk, ground marble and precipitated calcium carbonate (PCC).

Further additives that are conventional in papermaking can of course be used in combination with the chemicals according to the invention, for example anionic trash catchers (ATC), wet strength agents, dry strength agents, optical brightening agents, dyes, aluminium compounds, etc. Examples of preferably aluminium compounds include alum, aluminates, aluminium chloride, aluminium nitrate, and polyaluminium compounds, such as polyaluminium chlorides, polyaluminium sulphates, polyaluminium compounds containing chloride and/or sulphate ions, polyaluminium silicate sulphates, and mixtures thereof. The polyaluminium compounds may also contain other anions than chloride ions, for example anions from sulfuric acid, phosphoric acid, or organic acids such as citr ic acid and oxalic acid. When employing an aluminium compound in the present process, it is usually preferably to add it to the stock prior to the polymer component and micro- or nano-particulate material. Preferably addition levels of aluminium containing compounds is at least 0.001 kg/t, preferably from 0.01 to5 kg/t and more preferably from 0.05 to 1 kg/t, calculated as Al₂O₃ based on dry pulp and optional filler.

Examples of suitable anionic trash catchers include cationic polyamines, polymers or copolymers of quaternary amines, or aluminum containing compounds.

The process of this invention is used for the production of paper. The term “paper”, as used herein, include not only paper and the production thereof, but also other web-like products, such as for example board and paperboard, and the production thereof. The invention is particularly useful in the manufacture of paper having grammages below 150 g/m², preferably below 100 g/m², for example fine paper, newspaper, light weight coated paper, super calendered paper and tissue.

The process can be used in the production of paper from all types of stocks, both wood containing and woodfree. The different types of suspensions of cellulose-containing fibres and the suspensions should preferably contain at least 25% by weight and preferably at least 50% of weight of such fibres, based on dry substance. The suspensions comprise fibres from chemical pulp such as sulphate, sulphite and organosolv pulps wood-containing or mechanical pulp such as thermomechanic al pulp, chemo-thermomechanical pulp, refiner pulp and groundwood pulp, from both hardwood and softwood, and can also be based on recycled fibres, optionally from de-inked pulps, and mixtures thereof. Preferably the stock is a wood containing stock, which have high contents of salts (high conductivity).

The chemicals according to the present invention can be added to the aqueous cellulosic suspension, or stock, in conventional manner and in any order. It is usually preferably to add the cationic polymer to the stock before adding the aqueous silica-containing composition, even if the opposite order of addition may be used. It is further preferred to add the cationic polymer before a shear stage, which can be selected from pumping, mixing, cleaning, etc., and to add the aqueous silica- containing composition after that shear stage.

The aqueous silica-containing composition can be used as a flocculation agent in the treatment of water for the production of drinking water or as an environmental treatment of waters for instance in lakes. The composition can also be used as flocculation agent in the treatment of wastewater or waste sludges.

The invention is further illustrated in the following examples, which are not intended to limit the scope thereof. Parts and % relate to parts by weight and % by weight, respectively, and all solutions are aqueous, unless otherwise stated. The units are metric.

### EXAMPLE 1

Drainage performance was evaluated by means of a Dynamic Drainage Analyser (DDA), available from Akribi, Sweden. The drainage time was measured on a set volume of stock through a wire when removing a plug and applying vacuum to that side of the wire opposite to the side on which the stock is present.

Retention performance was evaluated by means of a nephelometer by measuring the turbidity of the filtrate, the white water, obtained by draining the stock. The trurbidity was measure in NTU (Nephelometric Turbidity Units).

The test stock was wood containing with a pH 7.2, the conductivity of the stock was 5.0 mS/cm, and the consistency was 1.42 g/l. The stock was stirred in a baffled jar at a speed of 1500 rpm throughout the test.

In the example a cationic polymer was added to the stock before the aqueous compositions according to the invention or the anionic reference. The cationic polymer was a cationic starch (C1) obtained by quarternisation of native potato starch with 3-chloro-2-hydroxypropyl dimethyl benzyl ammonium chloride to 0.5% N was added followed by 45 seconds of stirring, and then the anionic aqueous composition was added, followed by 15 seconds stirring before drainage.

Aqueous compositions according to the invention containing anionic polyurethane and colloidal silica were measured to evaluate their drainage and retention performance. All samples were diluted to 0.5% of solids before the evaluation of drainage properties. The anionic polyurethane (P1) is based on an anionic polyurethane of 15% solids, produced from glyceryl monostearate (GMS) and toluolyl diisocyanate (TDI), which forms a pre-polymer, which is reacted with dimethylol propionic acid (DMPA), with 30 mol % of GMS is replaced by DPMA/N-methyl diethanol amine (N-MDEA). The colloidal silica sol (S1) is of the type described in U.S. Pat. No. 5,447,604 having a molar ratio SiO₂:Na₂O of 10, specific surface area of 870 m²/g, S-value of 35% and silica content of 10.0% by weight. The drainage time measured on the stock with addition of 20 kg/t of C1 was 29 seconds and the turbidity was measured to 44 NTU. All additions are calculated as dry on dry stock. The drainage times derived from the different additions to the stock of the aqueous composition of the invention are summarised in Table 1.

TABLE 1

| | | Drainage time (sec)/Turbidity (NTU) at dosage of | | | |
|---|---|---|---|---|---|
| Sample | Ratio | 4 kg/t | 6 kg/t | 8 kg/t | 10 kg/t |
| S1 | | 19.7/35 | 16.9/31 | 15.6/30 | 16.0/29 |
| P1 | | 17.7/34 | 15.3/33 | 14.0/32 | 13.9/32 |
| S1/P1 | 4:1 | 17.3/33 | 14.0/30 | 13.5/28 | 14.0/27 |
| S1/P1 | 1:1 | 16.4/34 | 13.6/30 | 13.0/28 | 13.1/28 |
| S1/P1 | 1:4 | 16.5/33 | 13.9/31 | 13.3/29 | 12.9/29 |

The drainage times and turbidity for the composition S1/P1 show that when the two components (S1 and P1) are added as a composition they have a synergistic improvement on the drainage and retention performance.

### EXAMPLE 2

The aqueous compositions according to the invent ion containing anionic polyurethane (P2) based on an anionic polyurethane of 19% solids, produced from TDI and phenyl diethanol amine PDEA, which forms the pre-polymer, which is reacted with a mixture of DMPA and N-MDEA and of which 30 mol % of PDEA is replaced by DPMA/N-MDEA, and a colloidal silica (S2) having a molar ratio SiO₂:Na₂O of 20, specific surface area of 700 m²/g, S-value of 32% and silica content of 15.0%, were evaluated for drainage and retention performance. All the samples were diluted to 0.5% solids before the drainage and retention evaluation, which was performed exactly in the same manner as in Example 1 and with the same cationic starch in the same stock. The drainage time measured on the stock with addition of 20 kg/t of C1 was 27 seconds and the turbidity was measured to 45 NTU. All additions are calculated as dry on dry stock. The drainage times derived from the different additions to the stock of the aqueous composition of the invention are summarised in Table 2.

TABLE 2

| | | Drainage time (sec)/Turbidity (NTU) at dosage of | | | |
|---|---|---|---|---|---|
| Sample | Ratio | 2 kg/t | 4 kg/t | 6 kg/t | 8 kg/t |
| S2 | | 21.0/— | 15.7/— | 12.4/— | 12.9/— |
| P2 | | 21.8/44 | 18.0/39 | 12.9/31 | 12.0/29 |
| S2/P2 | 4:1 | 21.0/40 | 15.5/31 | 12.0/28 | 10.4/27 |
| S2/P2 | 1:1 | — | 13.8/30 | 11.0/27 | 9.8/27 |
| S2/P2 | 1:4 | — | 13.3/32 | 11.0/29 | 10.3/27 |

### EXAMPLE 3

In this example the test stock was SC-furnish (furnish for Super Calandered paper) with a pH 7.6, the conductivity of the stock was 0.5 mS/cm, and the consistency was 1,49 g/l. The stock was stirred in a baffled jar at a speed of 1500 rpm throughout the test. C1 was added to the stock in an amount of 20 kg/t (kg/tonne) in each test. The drainage time measured on the stock without any additives was 30 seconds and the turbidity was 98 NTU, the drainage time on the stock with addition of C1 only was 14.8 seconds and the turbidity was measured to 52 NTU. The anionic polyurethane used in this example was an anionic polyurethane (P3) of 15% solids, produced from GMS and TDI, which forms a pre-polymer, which is reacted DMPA and the colloidal silica (S3) described in U.S. Pat. No. 5,368,833 was a silica sol having a molar ratio SiO₂:Na₂O of 45, specific surface area of 850 m²/g, S-value of 20% and a silica content of 8.0%, and was modified with aluminium to 0.3% Al₂O₃.

The performance of the aqueous composition according to the invention was compared to the performance of the components added separately. In all tests C1 was added to the stock followed by 45 seconds of stirring, then the composition S3/P3 was added followed by 15 seconds of stirring. When the components were added separately the first component was added followed by 30 seconds of stirring and the second components was added followed by 15 seconds of stirring. All additions are calculated as dry on dry stock. The drainage times derived from the different additions to the stock are summarised in Table 3.

TABLE 3

| | | Drainage time (sec)/Turbidity (NTU) at dosage of | | | |
|---|---|---|---|---|---|
| Sample | Ratio | 1 kg/t | 2 kg/t | 3 kg/t | 4 kg/t |
| C1 + S3 | | — | — | — | 10.2/56 |
| C1 + P3 | | 13.9/54 | 13.0/55 | 12.0/56 | 13.0/55 |
| C1 + S3/P3 | 1:1 | 12.6/52 | 11.4/51 | 10.0/58 | 10.0/55 |
| C1 + S3/P3 | 3:1 | 12.2/52 | 11.1/54 | 10.7/55 | 10.4/55 |
| C1 + S3/P3 | 1:3 | 12.9/52 | 12.1/55 | 11.6/54 | — |
| C1 + S3 + P3 | 1:1 | — | — | — | 12.4/53 |
| C1 + P3 + S3 | 1:1 | — | — | — | 12.4/55 |

### EXAMPLE 4

The aqueous compositions according to the invention containing a 10% solution of an anionic lignosulphonate (LS1), which is the sodium salt of sulphonated and carboxylated Kraft lignin derived from soft wood, having a dry matter of 89.0% by weight, pH of 10.5, a sodium content of 9.5%, and a total sulphur content of 5.4%, wherein sulphur is bound to 4.2%, or a 10% solution anionic lignosulphonate (LS2), which is a sodium oxylignin derived from fermented spruce wood sulphite liquo r, having a dry matter of 93.0% by weight, pH of 8.5, a sodium content of 8%, and sulphur content of 3%, and colloidal silica S1, were evaluated for drainage and retention performance. All the samples were diluted to 0.5% solids before the drainage evaluation. The drainage time measured on the stock with addition of 20 kg/t of C1 was 29 seconds and the turbidity was measured to 44 NTU. All additions are calculated as dry on dry stock. The drainage times derived from the different additions to the stock of the aqueous composition of the invention are summarised in Table 4.

TABLE 4

| | | Drainage time (sec)/Turbidity (NTU) at dosage of | | | | | |
|---|---|---|---|---|---|---|---|
| Sample | Ratio | 2 kg/t | 4 kg/t | 6 kg/t | 8 kg/t | 10 kg/t | 12 kg/t |
| S1 | | 23.5/38 | 19.7/35 | 16.9/31 | 15.6/30 | 16.0/29 | — |
| LS1 | | — | 21.9/35 | 18.8/34 | 17.5/33 | 17.2/32 | — |
| LS2 | | — | 22.5/− | 19.9/36 | 17.9/35 | 17.8/34 | 18.5/− |
| S1/LS1 | 4:1 | — | 18.5/− | 15.3/29 | 14.4/26 | 14.5/25 | — |
| S1/LS1 | 1:1 | — | 18.8/− | 15.5/30 | 13.1/30 | 12.8/31 | — |
| S1/LS2 | 4:1 | — | 18.4/− | 15.1/31 | 13.2/28 | 12.5/27 | 12.4/25 |
| S1/LS2 | 1:1 | — | 19.2/− | 15.8/33 | 13.8/28 | 12.8/25 | 12.1/26 |

1. An aqueous silica-containing composition comprising an anionic organic polymer having at least one aromatic group and aggregated or microgel formed anionic silica-based particles, the aqueous silica-containing composition containing the anionic organic polymer having at least one aromatic group and total amount of anionic silica-based particles in an amount of at least 0.01% by weight based on the total weight of the aqueous silica-containing composition, with the proviso that the composition conta ins substantially no cellulose-reactive sizing agent and the anionic organic polymer having at least one aromatic group is not an anionic naphthalene sulphonate formaldehyde condensate.

2. An aqueous silica-containing composition obtainable by mixing an anionic organic polymer having at least one aromatic group with an aqueous alkali stabilised silica sol containing aggregated or microgel formed silica-based particles having an S-value in the range of from about 5 up to about 50%, to provide an aqueous silica-containing composition containing the anionic organic polymer having at least one aromatic group and total amount of silica-based particles in an amount of at least 0.01% by weight, based on the total weight of the aqueous silica-containing composition, with the proviso that the composition contains substantially no cellulose-reactive sizing agent and that the anionic organic polymer having at least one aromatic group is not an anionic naphthalene sulphonate formaldehyde condensate.

3. The aqueous silica-containing composition according to claim 1 or 2, wherein the silica-based particles have a specific surface are within the range of from 300 to 1300 m²/g.

4. The aqueous silica-containing composition according to claim 1 or 2, wherein the silica-based particles have an average particle size ranging from about 1 nm up to about 50 nm.

5. The aqueous silica-containing composition according to claim 1 or 2, wherein the silica-based particles have an average particle size ranging from about 1 nm up to about 10 nm.

6. The aqueous silica-containing composition according to claim 1 or 2, wherein pH of the aqueous solution of the anionic organic polymer having at least one aromatic group is adjusted to a pH of at least 8 prior to mixing with the silica-based particles.

7. The aqueous silica-containing composition according to claim 1 or 2, wherein the anionic organic polymer having at least one aromatic group polymer is a polyurethane, lignosulphonate, Kraft lignin or oxylignin.

8. The aqueous silica-containing composition according to any of claims 1 or 2, wherein the aqueous silica-containing composition has a negative charge density within the range of from 0.1 to 6 meq/g.

9. The aqueous silica-containing composition according to any of claims 1 or 2, with the proviso that the composition contains substantially no sizing agent.

10. A method for preparation of an aqueous silica-containing composition which comprises mixing in the presence of substantially no cellulose-reactive sizing agent an anionic organic polymer having at least one aromatic group with aggregated or microgel formed silica-based particles to provide an aqueous silica-containing composition containing the anionic organic polymer having at least one aromatic group and total amount of silica-based particles in an amount of at least 0.01% by weight, based on the total weight of the aqueous silica-containing composition with the proviso that the anionic organic polymer having at least one aromatic group is not an anionic naphthalene sulphonate formaldehyde condensate.

11. A method for preparation of an aqueous silica-containing composition which comprises mixing an anionic organic polymer having at least one aromatic group and a charge density of at least 0.1 meq/g of dry polymer, with aggregated or microgel formed silica-based particles to provide an aqueous silica-containing composition containing the anionic organic polymer having at least one aromatic group and total amount of silica-based particles in an amount of at least 0.01% by weight, based on the total weight of the aqueous silica-containing composition, with the proviso that the anionic organic polymer having at least one aromatic group is not an anionic naphthalene sulphonate formaldehyde condensate.

12. A method for preparation of an aqueous silica-containing composition which comprises desalinating an aqueous solution of an anionic organic polymer having at least one aromatic group, mixing the desalinated anionic organic polymer having at least one aromatic group with aggregated or microgel formed silica-based particles to provide an aqueous silica-containing composition containing the anionic organic polymer having at least one aromatic group and total amount of silica-based particles in an amount of at least 0.01% by weight, based on the total weight of the aqueous silica-containing composition with the proviso that the anionic organic polymer having at least one aromatic group is not an anionic naphthalene sulphonate formaldehyde condensate.

13. The method according to any of claims 10, 11 or 12, wherein the silica-based particles are contained in a silica sol having an S-value within the range of from about 5 up to about 50% prior to mixing with the anionic organic polymer having at least one aromatic group.

14. The method according to claims 10, 11 or 12, wherein the anionic organic polymer having at least one aromatic group is desalinated prior to mixing with the silica-based particles.

15. The method according to any of claims 10, 11 or 12, wherein the silica-based particles have a specific surface are within the range of from 300 to 1300 m660 ²/g.

16. The method according to any of claims 10, 11 or 12, wherein the silica-based particles have an average particle size ranging from about 1 nm up to about 50 nm.

17. The method according to any of claims 10, 11 or 12, wherein the silica-based particles have an average particle size ranging from about 1 nm up to about 10 nm.

18. The method according to any of claims 10, 11 or 12, wherein pH of the aqueous solution of the anionic organic polymer having at least one aromatic group is adjusted to a pH of at least 8 prior to mixing with the silica-based particles.

19. The method according to any of claims 10, 11 or 12, wherein the anionic organic polymer having at least one aromatic group polymer is a polyurethane, lignosulphonate, Kraft lignin or oxylignin.

20. The method according to any of claims 10, 11 or 12, wherein the aqueous silica-containing composition has a negative charge density within the range of from 0.1 to 6 meq/g.

21. The method according to claim 10, wherein the mixing is carried out in the presence of substantially no sizing agent.

22. An aqueous silica-containing composition obtainable by the method according to any claims 10, 11 or 12.

23. A flocculating agent for pulp and paper production and water purification utilizing the aqueous silica-containing composition of claim 1 or 2 in combination with at least one organic polymer.

24. A process for the production of paper from a suspension containing cellulosic fibres, and optionally fillers, comprising adding to the suspension at least one cationic organic polymer and an aqueous silica-containing composition comprising an anionic organic polymer having at least one aromatic group and aggregated or microgel formed anionic silica-based particles, the aqueous silica-containing composition containing the anionic organic polymer having at least one aromatic group and total amount of anionic silica-based particles in an amount of at least 0.01% by weight based on the total weight of the aqueous silica-containing composition, with the proviso that the composition contains substantially no cellulose-reactive sizing agent and the anionic organic polymer having at least one aromatic group is not an anionic naphthalene sulphonate formaldehyde condensate.

25. The process according to claim 24, wherein the cationic organic polymer is cationic starch or cationic polyacrylamide.

26. The process according to claim 24, wherein the cationic organic polymer has at least one aromatic group.

27. The process according to claim 25, wherein the cationic organic polymer has at least one aromatic group.

28. The aqueous silica-containing composition according to claim 24, wherein the silica-based particles have a specific surface area within the range of from 300 to 1300 m²/g.

29. The aqueous silica-containing composition according to claim 24, wherein the silica-based particles have an average particle size ranging from about 1nm up to about 50 nm.

30. The aqueous silica-containing composition according to claim 24, wherein the silica-based particles have an average particle size ranging from about 1 nm up to about 10 nm.

31. The aqueous silica-containing composition according to claim 24, wherein pH of the aqueous solution of the anionic organic polymer having at least one aromatic group is adjusted to a pH of at least 8 prior to mixing with the silica-based particles.

32. The aqueous silica-containing composition according to claim 24, wherein the anionic organic polymer having at least one aromatic group polymer is a polyurethane, lignosulphonate, Kraft lignin or oxylignin.

33. The aqueous silica-containing composition according to claim 24, wherein the aqueous silica-containing composition has a negative charge density within the range of from 0.1 to 6 meq/g.

34. The aqueous silica-containing composition according to claim 24, with the proviso that the composition contains substantial ly no sizing agent.

35. A process for the production of paper from a suspension containing cellulosic fibres, and optionally fillers, comprising adding to the suspension at least one cationic organic polymer and an aqueous silica-containing composition obtainable by mixing an anionic organic polymer having at least one aromatic group with an aqueous alkali stabilised silica sol containing aggregated or microgel formed silica-based particles having an S-value in the range of from about 5 up to about 50%, to provide an aqueous silica-containing composition containing the anionic organic polymer having at least one aromatic group and total amount of silica-based particles in an amount of at least 0.01% by weight, based on the total weight of the aqueous silica-containing composition, with the proviso that the composition contains substantially no cellulose-reactive sizing agent and that the anionic organic polymer having at least one aromatic group is not an anionic naphthalene sulphonate formaldehyde condensate.

36. The process according to claim 35, wherein the cationic organic polymer is cationic starch or cationic polyacrylamide.

37. The process according to claim 35, wherein the cationic organic polymer has at least one aromatic group.

38. The process according to claim 36, wherein the cationic organic polymer has at least one aromatic group.

39. The aqueous silica-containing composition according to claim 35, wherein the silica-based particles have a specific surface are within the range of from 300 to 1300 m²/g.

40. The aqueous silica-containing composition according to claim 35, wherein the silica-based particles have an average particle size ranging from about 1 nm up to about 50 nm.

41. The aqueous silica-containing composition according to claim 35, wherein the silica-based particles have an average particle size ranging from about 1 nm up to about 10 nm.

42. The aqueous silica-containing composition according to claim 35, wherein pH of the aqueous solution of the anionic organic polymer having at least one aromatic group is adjusted to a pH of at least 8 prior to mixing with the silica-based particles.

43. The aqueous silica-containing composition according to claim 35, wherein the anionic organic polymer having at least one aromatic group polymer is a polyurethane, lignosulphonate, Kraft lignin or oxylignin.

44. The aqueous silica-containing composition according to claim 35, wherein the aqueous silica-containing composition has a negative charge density within the range of from 0.1 to 6 meq/g.

45. The aqueous silica-containing composition according to claim 35, with the proviso that the composition contains substantially no sizing agent.
